(19) United States
(12) Patent Application Publication
(10) Pub. No.: US 2007/0024137 A1
(43) Pub. Date: Feb. 1, 2007

(54) Motor

(75) Inventors: Takaya Otsuki, Kyoto (JP); Takamasa Yamashita, Kyoto (JP); Shinji Takemoto, Kyoto (JP)

Correspondence Address: JUDGE & MURAKAMI IP ASSOCIATES, DOJIMIA BUILDING, 7TH FLOOR, 6-8 NISHITEMMA 2-CHOME, KITA-KU, OSAKA-SHI, 530-0047, JP

(73) Assignee: Nidec Corporation, Kyoto (JP)

(21) Appl. No.: 11/461,000

(22) Filed: Jul. 31, 2006

(30) Foreign Application Priority Data
Jul. 29, 2005 (JP) JP-2005-220945

(51) Int. Cl. H02K 5/16; F04B 17/00

(52) U.S. Cl. 310/90; 417/423.12

(57) ABSTRACT

A thrust plate for supporting a bottom end of a shaft in an axial direction is provided on a top surface of a bottom section of a bearing housing. An attracting magnet for attracting the shaft, which is made of a magnetic material, in the axial direction is provided below the thrust plate. A substantially cup shaped magnet holder is provided surrounding a periphery of the attracting magnet. The magnet holder retains the attracting magnet by a bottom section and a radial periphery surface of the attracting magnet. The magnet holder is integrally formed, by an insert molding, with the bottom section of the bearing housing.

### BACKGROUND OF THE INVENTION

1. Technical Field

The present invention relates to a bearing mechanism for noise reduction and reduction of motor thickness by magnetically attracting a rotor section of a motor.

2. Description of the Related Art

Currently, electronic equipments have installed therein a plurality of motors. The motors are used for running fans and for driving driving motors. Since more and more of the electronic equipments are used in houses and office spaces, the electronic equipments are required to run more quietly than before. Conventionally, a rotor section (e.g., rotor unit) of a motor having applied thereon a bearing mechanism commonly known as a sleeve bearing is designed such that the rotor section can freely move toward and away from a stator section of the motor in an axial direction. Some motor structures have been designed in order to prevent the rotor section from moving freely in the axial direction. One of such motor structures is a structure in which a center of magnetic force of a rotor magnet is displaced to a position axially higher than a center of a magnetic force of a stator core such that the rotor section is magnetically pulled downward in the axial direction. By this structure, an end of a shaft of the rotor section makes contact with a thrust plate provided in the stator section of the motor, thereby preventing the rotor section from moving freely in the axial direction.

However, with such structure as mentioned above, there may be situations in which magnetic force strong enough to retain the rotor section are not generated. Especially, when the motor having such structure as mentioned above is installed on an electric equipment, and when the rotor section is at a position vertically below the motor, under the rotor section's own weight, the end of the shaft may be detached from the thrust plate and move in the axial direction. That is, when the motor is installed on an electric equipment, the rotor cannot be attached to the electric equipment while the rotor section is facing vertically downward. Further, when an external pressure is applied to the motor in the axial direction, the rotor section of the motor may be forced to move in the axial direction. When such pressure is applied to the motor, hitting noise, which is generated by the end of the shaft and the thrust plate making contact with and detaching from one another, may occur. By this, there may be situations in which the motor noise is increased, or, due to the contact between the end of the shaft and the thrust plate, surfaces of the end of the shaft and the thrust plate are damaged. Furthermore, due to the displacement of the magnetic center of the stator core and that of the rotor magnet, magnetic noise or magnetic vibration may occur. The motor noise, magnetic noise and magnetic vibration of the motor will be problematic for the electronic equipment which is required to run quietly. In the structures, as described above, where the magnetic center of the rotor magnet is displaced upward in the axial direction with respect to the magnetic center of the stator core, positional relation between the rotor magnet and the stator core need to be minutely defined prior to assembling the motor so as to compensate for variations of thrust strength among products. This requires a high precision in designing and assembling the rotor magnet, thereby increasing a number of steps involved in a production of the motor.

### BRIEF SUMMARY OF THE INVENTION

A bearing unit according to the present invention comprises a magnet provided below a bottom of a shaft thereof so as to retain therein the shaft. The magnet is affixed to a magnet holder. The magnet holder, which is formed by using an insert molding or the like, is tightly affixed to a bearing retaining section which is for affixing a sleeve.

An aforementioned configuration where the magnet holder is affixed to the bearing retaining section allows a strong joint strength therebetween. Also, since a surface of the magnet holder and the bearing retaining section are tightly affixed to one another, an oil leakage from a section bordering between the magnet holder and the bearing retaining section will be prevented.

With the aforementioned configuration, where the oil leakage is prevented, a thickness of the bearing retaining section can be reduced such that a bottom surface of the magnet holder is exposed to an exterior of the bearing retaining unit. The aforementioned configuration is beneficial for reducing the thickness of the bearing unit.

On a circumferential surface of the magnet holder, there may be a convexed area or a concaved area. The convexed or concaved area provided on the magnet holder is beneficial for further strengthening a connecting strength between the magnet holder and the bearing retaining section.

### BRIEF DESCRIPTION OF THE SEVERAL VIEWS OF THE DRAWINGS

FIG. 1 is a diagram illustrating a cross section of an embodiment of a motor of the present invention.

FIG. 2A is a diagram illustrating a cross section of an embodiment of a magnet holder of the present invention.

FIG. 2B is a diagram illustrating a perspective view of an embodiment of the magnet holder of the present invention.

FIG. 3A is a diagram illustrating a perspective view of an embodiment of a thrust plate of the present invention.

FIG. 3B is a diagram illustrating a perspective view of a variation of the thrust plate of the present invention.

FIG. 4 is a diagram illustrating a pathway for an airflow generated when the shaft is inserted into the sleeve, wherein arrows indicate the airflow.

FIG. 5 is a flowchart for an insert molding generating an embodiment of a magnet holder of the present invention.

FIG. 6 is a diagram illustrating an embodiment of a die for an injection molding.

FIG. 7 is a diagram illustrating an alienated space of the die for the injection molding of the present invention.

FIG. 8 is a diagram illustrating resin being pressure fed into the die for the injection molding of the present invention.

### DETAILED DESCRIPTION OF THE INVENTION

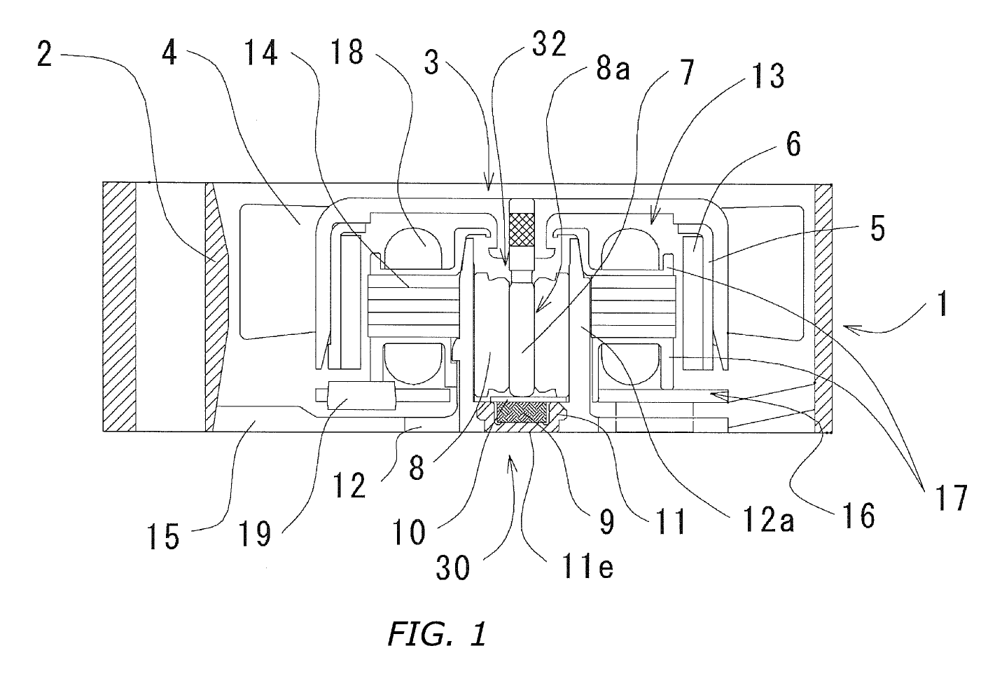

Hereinafter, embodiments of a motor of the present invention will be described with reference to FIGS. 1 through 8. Note that in the description of the preferred embodiments of the present invention herein, words such as upper, lower, left, right, upward, downward, top and bottom for explaining positional relationships between respective members and directions merely indicate positional relationships and directions in the drawings. Such words do not indicate positional relationships and directions of the members mounted in an actual device.

### First Embodiment

FIG. 1 is a diagram illustrating a cross section of an embodiment of a motor of the present invention. Hereinafter, the motor used for a fan will be described.

A fan 1 has a structure in which a rotor section 3, which drives rotationally once an external electric current is applied thereto, has attached thereto an impeller 4 having a plurality of blades. The rotor section 3 includes a shaft 7. The shaft 7 and the impeller 4 are integrally provided such that one end of the shaft 7 is affixed to a center section of the impeller 4. The impeller 4 is formed by a resin injection mold. The one end of the shaft 7 is inserted in a die forming the impeller 4, and the one end will be covered by resin forming the impeller 4 thereby affixing the shaft 7 to the impeller 4.

Further, the fan 1 includes therein a bearing unit 30. The bearing unit 30 includes therein the shaft 7, a bearing retaining section, a sleeve 8, and an attracting magnet which will be described later.

At a center section of a frame 12, a substantially cup shaped bearing housing 12a, which is the bearing retaining section, is provided. A bearing housing 12a and the frame 12 are formed integrally and seamlessly with one another by using an injection molding.

The sleeve 8 is supported by being press fit into the bearing housing 12a. Further, the sleeve 8 includes therein an through hole 8a so as to allow the shaft 7 to rotate therein. The shaft 7 is inserted through the through hole. The sleeve 8 is comprised of a porous sintered metallic material and is formed by a powder metallurgy method. The sleeve 8 is impregnated with oil as a lubricant for the shaft 7 to rotate therein. Therefore, the shaft 7, or the rotation thereof, is supported by the sleeve 8 through the lubricant.

A radial bearing mechanism 32 for supporting, while maintaining the aforementioned lubricant as a working fluid, the shaft 7 when the rotor section 3 rotates is formed between an exterior surface of the shaft 7 and an interior surface of the sleeve 8. The radial bearing mechanism 32 is comprised of, for example, a sliding bearing, a fluid dynamic bearing or the like.

A stator section 13 is supported by an exterior section of the bearing housing 12a. The stator section 13 is comprised of a stator core, a coil, an insulator 17 for insulating the stator core from the coil, and a circuit board 16. The stator core is surrounded by the insulator 17, which is composed of an electrical insulating material so as to electrically insulate an upper end, a bottom end and a plurality of teeth sections. The coil winds each teeth section along with the insulator 17. A circuit board 16 having mounted thereon a driver circuit is provided at a bottom part of the stator section 13. The circuit board 16 controls a rotary drive of the rotor section 3. The circuit board 16 comprises a printed board having mounted thereon electronic components. A design of a circuit to be mounted on the printed board is printed on a surface of the circuit board 16, to which the coil and electronic components are electrically connected so as to form a drive control circuit. The circuit board 16 is affixed to a bottom end of the insulator 17. A magnetic field is generated to the stator core when externally supplied electricity is applied to the coil through the electronic components including IC and a hall element 19.

On an inner circumference of the impeller 4, a multipoled rotor magnet 6 is provided. Also, a rotor yoke 5 for retaining from a circumference of the rotor magnet 6 the rotor magnet 6 is provided so as to reduce an amount of magnetic flux which may be leaked to the fan 1. When the shaft 7, which is integrally formed with the impeller 4, is inserted into the sleeve 8, the rotor magnet 6 and the stator core will be positioned such that the rotor magnet 6 and the stator core face one another radially. Rotary torque, which is generated in the rotor section 3 due to a mutual effect between a magnetic field generated by the stator core and a magnetic field generated by the rotor magnet 6, rotates the rotor section 3 around the shaft 7. Stability of the rotation of the rotor section 3 is controlled by a drive IC switching a voltage output after the hall element 19 detects a change in the flux generated by the rotating rotor magnet 5. The impeller 4 retained on an exterior circumference of the rotor section 3 rotates due to the rotary drive of the rotor section 3, thereby generating an airflow.

The frame 12 is positioned facing the circuit board 16 in an axial direction, and is formed to be a disc shape having an outer diameter which is substantially equivalent to, but not limited to, an outer diameter of the circuit board 16. An air channel section 2 for forming a pathway for the airflow generated by the impeller 4 is provided radially outward of the frame 12. A plurality of ribs 15 which stretch outward in a radial direction are provided on an exterior of the frame 12. An end of each rib 15 in a radial direction is connectedly affixed to the air channel section 2. The rotor section 3 including the impeller 4 is contained in an inner space of the air channel section 2.

A thrust plate 10 for supporting the shaft 7 at a bottom end of the shaft 7 in the axial direction is provided at an upward facing bottom end of the bearing housing 12a. Since the bottom end of the shaft 7 makes contact with the thrust plate 10, the contacting surfaces slide against one another. Therefore, the thrust plate 10 is to be composed of a material durable against friction, which occurs when the thrust plate 10 and the shaft 7 slide against one another.

An attracting magnet 9 for magnetically attracting the shaft 7, which is composed in part of a magnetic material, is provided at a bottom end of the thrust plate 10. A substantially cup shaped magnet holder 11 is provided surrounding a periphery of the attracting magnet 9. The magnetic holder 11 retains the attracting magnet 9 by retaining a bottom end and the periphery in a radial direction of the attracting magnet 9. The magnet holder 11 and the attracting magnet 9 are affixed to one another by a magnetic force of the attracting magnet 9. Note that when the magnet holder 11 and the attracting magnet 9 need to be affixed to one another more firmly than by the magnetic force of the attracting magnet 9, an adhesive may be used therebetween. Since the magnet holder 11 is a magnetic substance, the magnet holder 11 significantly reduces an amount of the magnetic flux which may be leaked out of the attracting magnet 9 to the fan 1. Further, due to a magnetic circuit generated by the magnet holder 11 and the attracting magnet 9, a magnetic flux density of the attracting magnet 9 will be increased thereby increasing the attraction force of the attracting magnet 9 attracting the shaft 7. Therefore, the rotor section 3 will become stabilized in the axial direction. Consequently, compared with a conventional method in which an axial magnetic center of a section equivalent to the rotor magnet 6 is modified in accordance with an axial magnetic center of a section equivalent to the stator section 13, noise generated by the magnetic field will be reduced.

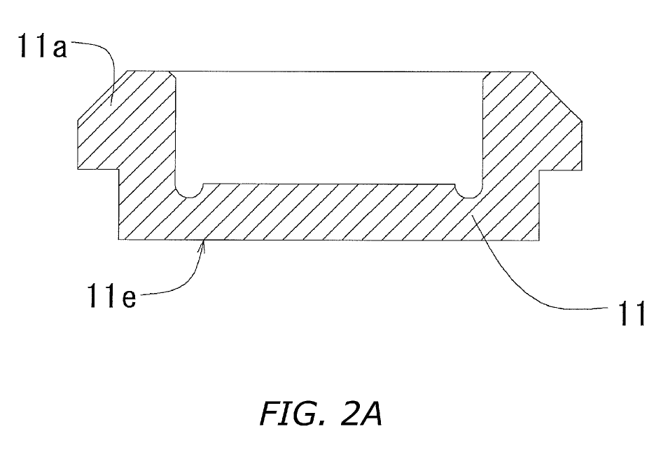

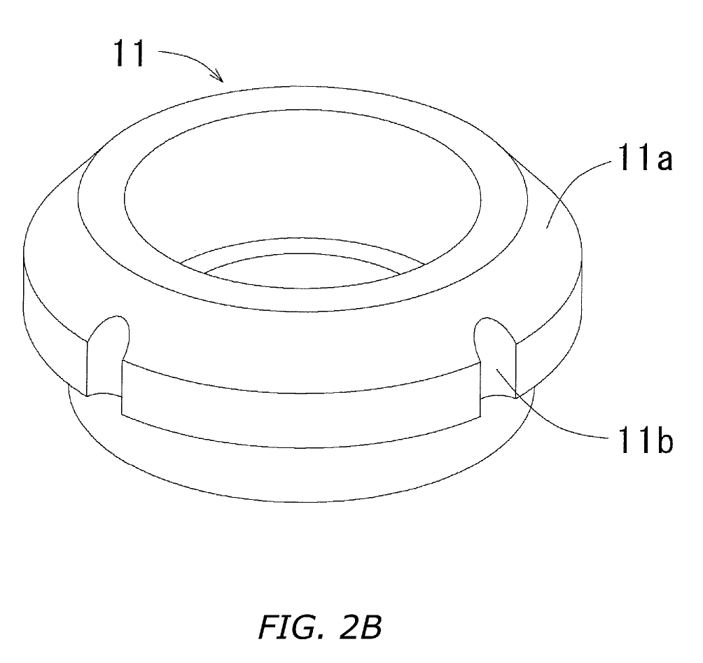

The magnet holder 11 is, as illustrated in FIG. 2, formed at a bottom surface of the bearing housing 12a by an insert molding method, which will be described below, such that the magnet holder 11 and the bearing housing 12a are integrated with one another and are facing a same direction. That is, an interior of the substantially cup shaped magnet holder 11 and the interior of the bearing housing 12a are integrally formed in a same manner that the attracting magnet 9 is affixed the interior of the bearing unit 30.

Melted resin is applied on a section of a surface, of the magnet holder 11, contacting with the bearing housing 12a and with the frame 12. The melted resin is cooled on the surfaces so as to connect surfaces between the magnet holder 11 and the bearing housing 12a, and between the magnet holder 11 and the frame 12. Therefore, the magnet holder 11 is tightly connected to the bearing housing 12a and to the frame 12 such that no space is generated between the magnet holder 11 and the bearing housing 12a, and between the magnet holder 11 and the frame 12, thereby preventing an oil leakage to an exterior of the fan 1 from an area near a bottom end, of the frame 12, connecting to the magnet holder 11.

Further, an exterior of a substantially cup shaped base section 11e is exposed to the exterior of the frame 12. Therefore, it becomes possible to reduce a thickness of the bearing unit. Note that the base section 11e of the magnet holder 11 may be, instead of being exposed to the exterior of the frame 12, covered in resin in order to strengthen the connection between the magnet holder 11 and the bearing housing 12a, and the magnet holder 11 and the frame 12.

Further, the magnet holder 11 of the present embodiment is composed of a magnetic sintered metal. That is, the magnet holder 11 is a porous sintered metal formed by the metal ceramic process. When an inner diameter of the magnet holder 11 is greater than φ3 mm, the magnet holder can easily be formed by pressing a magnetic metal plate. Therefore, the magnet holder 11 can be formed by a method other than the metal ceramic process depending on a size of the magnet holder 11. Since the base section 11e of the magnet holder 11 is exposed to the exterior of the frame 12, it is important that the oil retained in the bearing mechanism is prevented from being leaked to the fan 1 through the interior of the magnet holder 11 and the base section 11e. In order to prevent the oil leakage, there is a method to reduce a number and a size of pores formed in the interior of the magnet holder 11. For example, the magnet holder 11 is to be composed mainly of iron wherein less than 10% of a total weigh thereof is composed of an iron-copper type material such that a weight density of the magnet holder 11 is 6.45 to 6.80 g/cm³. With such material, it is possible to reduce the number and the size of pores formed in the interior of the magnet holder 11, thereby preventing the oil leakage. However, using a material different from the aforementioned material to compose the magnet holder 11 may form pores having a different size. Therefore, a new standard for controlling the weight density needs to be applied in accordance with the new material.

Further, a steam treatment process can be applied to the magnet holder 11. The steam treatment process is a process in which the magnet holder 11 is heated for approximately 30 to 60 minutes by a superheated steam having a temperature between 500 to 600° C. so as to form an oxide film (e.g., Fe304) on a surface of the magnet holder 11, thereby improving durability of the surface of the magnet holder 11 against friction and corrosion. When the oxide film formed on the surface of the magnet holder 11 covers the pores, the oil leakage to the fan 1 will be prevented.

Further, a masking process can be applied on the surface of the magnet holder 11 so as to prevent the oil leakage to the fan 1 through the pores of the magnet holder 11. The masking process is a process in which a coating agent is applied on the surface of the magnet holder 11, or a process in which the surface of the magnet holder is ground until the surface is clear of the pores, thereby preventing the oil leakage to the fan 1 from the magnet holder 11. More particularly, the masking process can be: applied by grinding, using a cutting tool, the surface of the magnet holder 11; a shot blasting process in which metal powder or particle is sprayed on the magnet holder 11 so as to remove the pores from the surface thereof; or a coating process in which resin is coated on the surface of the magnet holder 11 so as to cover the pores on the surface thereof.

Further, the magnet holder 11 may be coated with oil repellent resin so as to cover the pores on, at least, the surface of the magnet holder 11 thereby covering majority of pores formed inside the magnet holder 11. By applying any one, or combination, of the processes mentioned above, the magnet holder 11 is, by an effect of the oil repellent resin, able to repel oil that is being leaked thereto. Note that the masking process or/and the process in which the magnet holder 11 is impregnated with the oil repellent resin is to be executed prior to when the magnet holder 11 is formed inside the frame 12.

Another means to prevent the oil from penetrating the pores formed inside the magnet holder 11 are as follows. Prior to when the magnet holder 11 is formed inside the frame 12, an entire circumference of an upper border between the magnet holder 11 and the frame 12, and an entire exposed area of the upper section of the magnet holder 11 are coated with the oil repellent resin. Since the entire circumference of the upper border between the magnet holder 11 and the frame 12, and the entire exposed area of the upper section of the magnet holder 11 are coated with the oil repellent resin, the oil repellent effect of the surface of the magnet holder 11 prevents a permeation of the leaked oil into the pores formed inside the magnet holder 11.

FIG. 2A is a diagram illustrating a cross section of the magnet holder 11. FIG. 2B is a diagram illustrating a perspective view of the magnet holder 11. As illustrated in FIGS. 2A and 2B, a toric convex section 11a, which protrudes outward radially, is provided on upper part of a circumference of the magnet holder 11. Further, on a circumference of the convex section 11a, 4 of concave sections 11b are provided, wherein each concave section 11b is equally positioned circumferentially from one another. Note that there may be more than or less than 4 concave sections 11b provided on the surface of the convex section 11a.

Since the convex section 11a and the concave section 11b are provided on the magnet holder 11, wherein the frame 12 and the magnet holder 11 are integrally formed by the insert molding, a retaining strength of the frame 12 retaining the magnet holder 11, and a rotary strength of the frame will be improved. Inside the injection molding, an injection pressure at which the melted resin is injected exceeds, at maximum, 100 kg/cm². That is, inside the insertion molding, a pressure exceeding 1000 kg/cm² is applied on the magnet holder 11, which is a material that is inserted. Although such high pressure is applied to the magnet holder 11 in the radial direction, due to the convex section 11a provided on the circumference of the magnet holder 11, a radial distortion, which may occur to the magnet holder 11, is kept to a minimum. Configurations of the convex section 11a and the concave section 11b are not restricted to as those illustrated in Figs. The configurations can be modified as long as they are able to: improve the retaining strength of the frame 12 retaining the magnet holder 11; and keep the distortion occurring to the magnet holder 11 due to the injection pressure to the minimum.

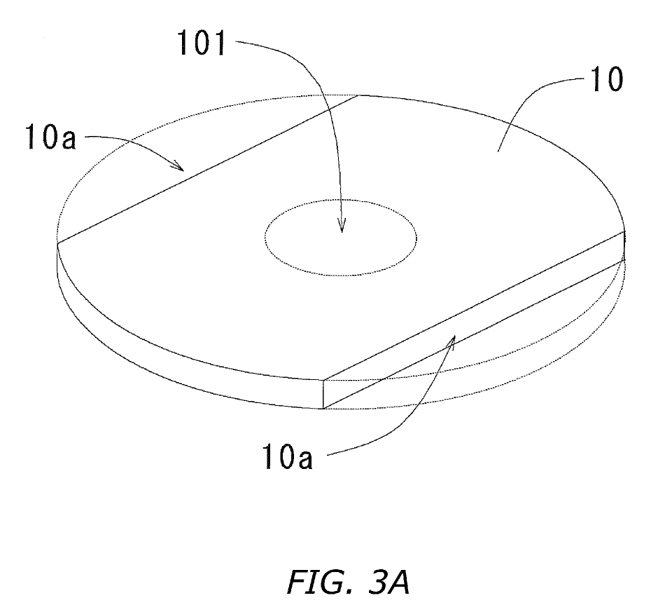

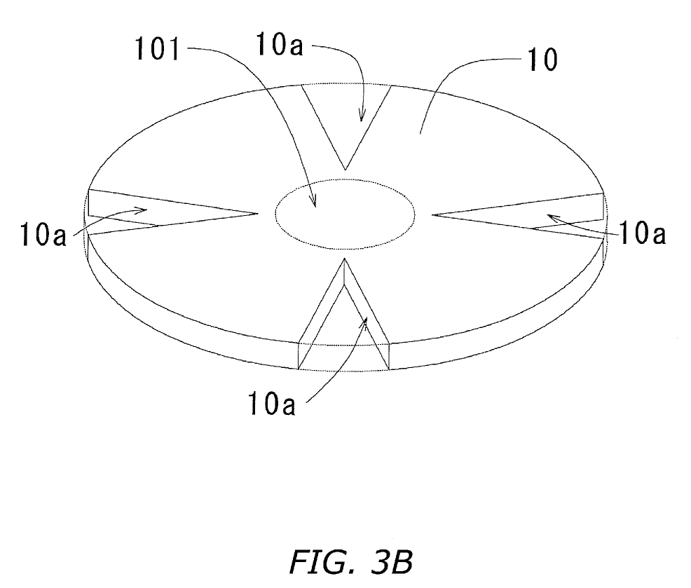

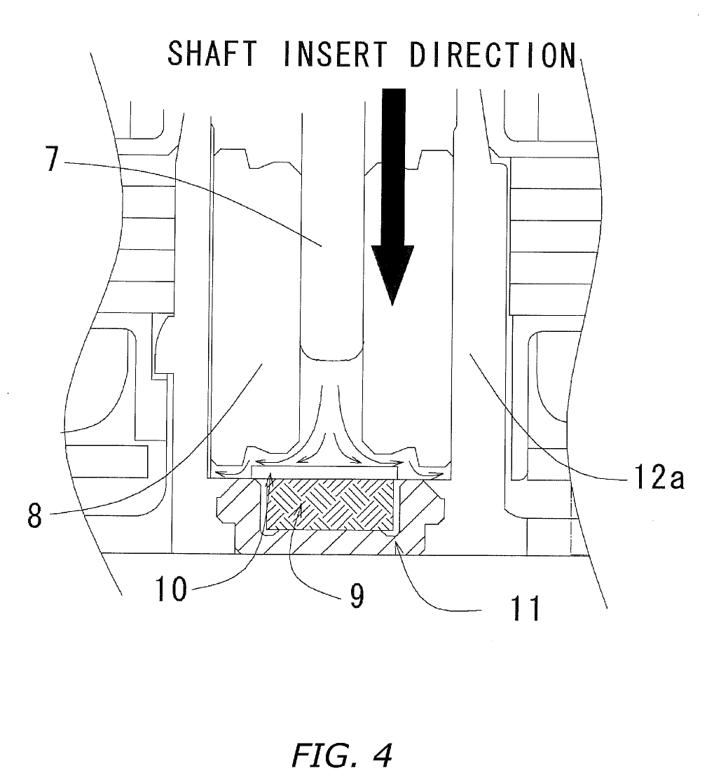

FIG. 3 is a diagram illustrating a perspective view of the thrust plate 10. FIG. 4 is a diagram illustrating, into details of, a pathway for airflow generated when the shaft 7 is inserted into the sleeve 8, wherein arrows indicate the airflow. As illustrated in FIG. 3, the thrust plate 10 is disc shaped having on its circumference at least one section that is notched.

As illustrated in FIG. 4, when inserting the shaft 7 into the through hole 8a of the sleeve 8, a nearly closed space (hereinafter, closed space) will be generated by a tip of the shaft 7, an interior of the sleeve 8 and the thrust plate 10. When the tip of the shaft 7 is inserted into the closed space, air inside the closed space is exhausted to the fan 1 following the pathway for the airflow, which is indicated by the arrow, through the notched section of the thrust plate, and a gap between the exterior of the sleeve 8 and the interior of the bearing housing 12a, or through a small hole provided inside the sleeve 8.

A configuration of the notched section 10a provided on the circumference of the thrust plate 10 is designed such that the air inside the closed space is to be exhausted through the notched section 10a when shaft 7 is inserted through the sleeve 8. The notched section 10a can be in any shape as illustrated in FIGS. 3A and 3B if the notched section 10a is not provided at a section where the thrust plate 10 and the tip of the shaft 7 meet.

As for means to form the frame 12, an injection molding, or the like, in which melted resin is pressure fed into a precision metal die so as to form the resin into a predetermined shape, can be used. Also, the frame 12 can be formed by a die-cast molding in which melted metal is poured into a precision die so as to form the metal into a predetermined shape. When the die-cast molding is used to form the frame 12, material such as aluminum, aluminum base alloy or the like may be used.

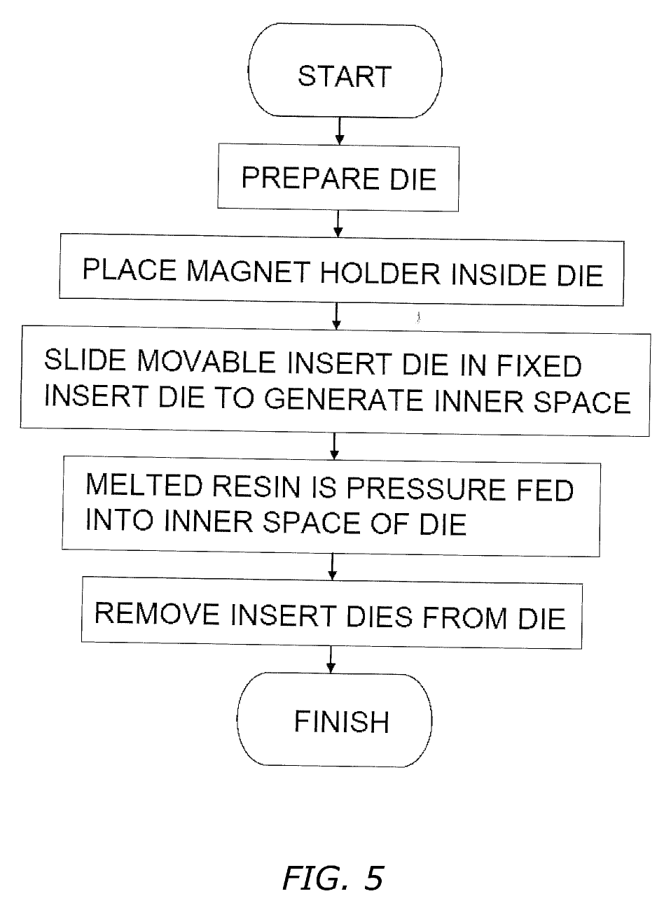

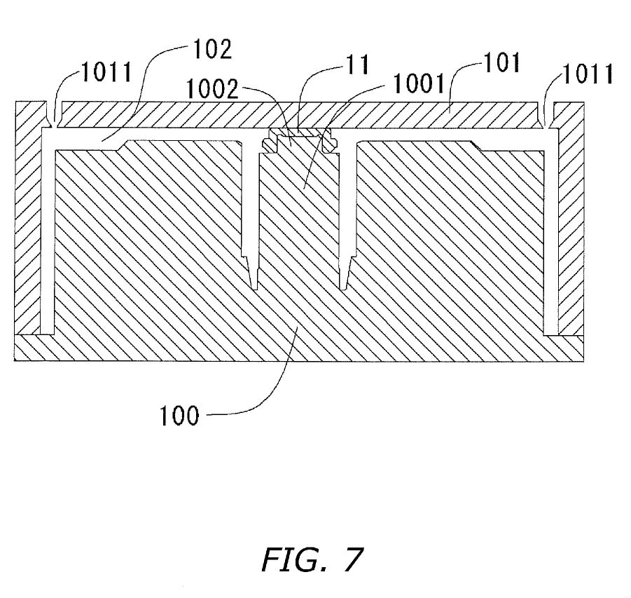

Next, a molding method for the insert molding will be described with reference to FIG. 5. The frame 12, the air channel section 2 and the rib 15 are molded integrally having no seams therebetween. First, a die to mold the frame 12 therein is prepared (step S11). The die in which the frame 12 is molded is comprised of, as illustrated in FIG. 7, a fixed insert die 100 and a movable insert die 101. When the fixed insert die 100 and the movable insert die 101 are put together, an inner space of die 102 will be generated.

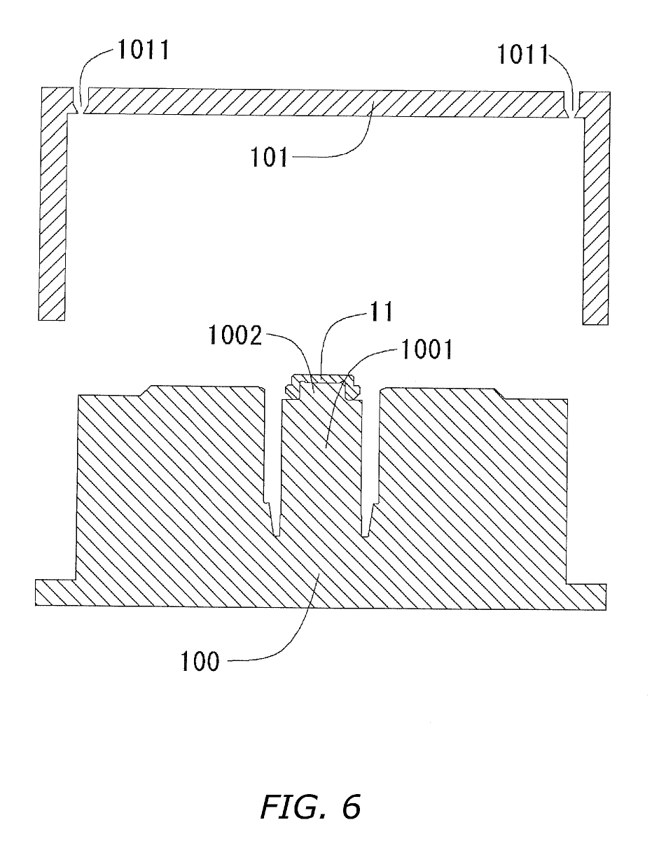

In the inner space of die 102, the frame 12, the air channel section 2 and the rib 15 are integrally formed having no seams therebetween. In the fixed insert die 100, a region 1001 (hereinafter, referred to as “bearing housing interior forming section 1001”) which corresponds to the interior of the bearing housing 12a will be provided. At a tip of the bearing housing interior forming section 1001, a region 1002 (hereinafter, referred to as “magnet holder retaining section 1002”) which fits the interior of the substantially cup shaped magnet holder 11 will be provided. The interior of the magnet holder 11 is fittingly placed on the magnet holder retaining section 1002 while the movable insert die 101 and the fixed insert die 100 are separated from one another as illustrated in FIG. 6 (step S12).

The movable insert die 101 is slidingly placed over the fixed insert die 100. Then the inner space of die 102 will be generated between the movable insert die 101 and the fixed insert die 100 (step S13). Also, the movable insert die 101 and the fixed insert die 100 are structures such that the bottom section of the magnet holder 11 and the movable insert die 101 meet.

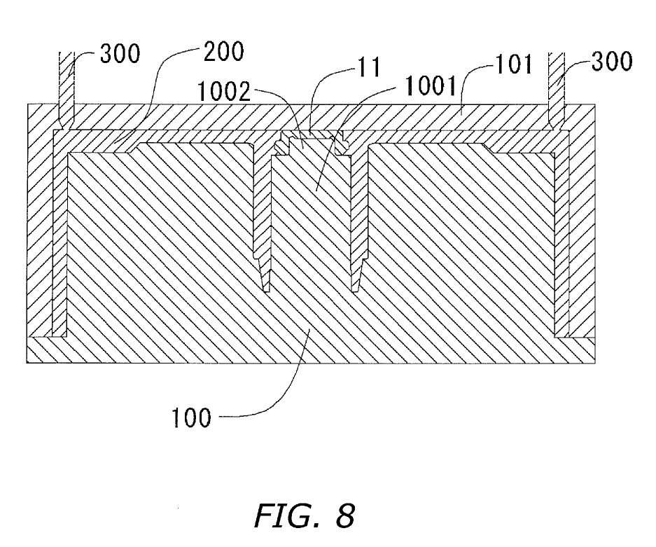

A gate 1011 through which the melted resin is pressure fed into the inner space of die 102 is provided in the movable insert die 101. As illustrated in FIG. 8, melted resin 200 is, through a nozzle 300 provided in the gate 1011, pressure fed into the inner space of die 102 (step S14). The melted resin 200 is pressure fed into the inner space of die 102 so as to fill up the entire space of the inner space of die 102. Then, the exterior of the magnet holder 11 will be surrounded by the melted resin 200. Although injection pressure is applied on the exterior of the magnet holder 11 when the melted resin is pressure fed into the inner space of die 102, due to the convex section 11a provided on the exterior of the magnet holder 11, distortion occurring on the exterior of the magnet holder 11 is kept to a minimum.

Next, the melted resin 200 filling up the inner space of die 102 is cooled while retaining a shape of the inner space of die 102. That is, the melted resin 200 is fixed surrounding the exterior of the magnet holder 11 inside the inner space of die 102.

When the movable insert die 101 is removed from the fixed insert die 100, the frame 12, the air channel section 2, the rib 15 and the magnet holder 11 are integrally formed (step S15).

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustrative only, and not for limiting the invention as defined by the appended claims and their equivalents.

For example, although the shaft rotates in each of the embodiments described above, the shaft may be fixed and the sleeve or/and the bearing retaining section may rotate in stead.

What is claimed is:

1. A bearing unit having been installed on an electric motor, the unit comprising:
a sleeve having a substantially cylinder shaped through hole;
a substantially cylinder shaped shaft for rotating relatively to the sleeve, wherein the shaft is inserted through the through hole;
a radial bearing mechanism, formed of an inner circumferential surface of the through hole, a peripheral surface of the shaft, and lubricant liquid filling up a minute gap generated between the inner circumferential surface of the through hole and the peripheral surface of the shaft;
a bearing retaining section for retaining at an inner circumference thereof the sleeve, wherein the bearing retaining section is formed by using a die-cast molding or an injection molding;
an attracting magnet for attracting a bottom section of the shaft in an axially downward direction, wherein the attracting magnet is provided at an inner bottom section of the bearing retaining section; and
a magnet holder, being made of a magnetic material, for setting therein the attracting magnet and for retaining the attracting magnet by a bottom surface and a radial peripheral surface thereof, wherein:
the bearing retaining section and the magnet holder are formed integrally with one another by using an insert molding.

2. The bearing unit according to claim 1, wherein a bottom section of the magnet holder is exposed out of a bottom section of the bearing retaining section.

3. The bearing unit according to claim 1, wherein the magnet holder is made of a magnetic sintered material.

4. The bearing unit according to claim 1, wherein on at least one portion of a circumferential surface of the magnet holder, formed is either a convex section which protrudes outwardly in a radial direction, or a concave section which is an inwardly indented section in the radial direction.

5. The bearing unit according to claim 1, wherein on at least one portion of the circumferential surface of the magnet holder, formed is either a convex section which extends outwardly in a circumferential direction, or a concave section which is an inwardly indented section in the circumferential direction.

6. The bearing unit according to claim 3, wherein a masking process is applied on a surface of the magnet holder.

7. The bearing unit according to claim 3, wherein the magnet holder is impregnated with oil repellent resin prior to when the magnet holder is formed by an insert molding.

8. The bearing unit according to claim 3, wherein an entire periphery of a border section, bordering between the magnet holder and an inner surface of the bearing retaining unit, and an exposed section of an inner periphery of the bearing retaining section have applied thereon an oil repellent coating.

9. The bearing unit according to claim 1, wherein a thrust plate durable against friction is provided between a top surface of the attracting magnet and a bottom surface of the shaft.

10. The bearing unit according to claim 9, wherein the thrust plate is substantially disc shaped and at least one area of a periphery thereof is notched.

11. An electrically operated motor having installed thereon the bearing unit according to claim 1, the motor comprising:
a rotor section having therein the shaft and a rotor magnet for rotating around a rotation axis;
a stator having therein a coil provided at a position facing the rotor magnet in either a radial direction or an axial direction for causing the rotor section to drive rotationally, wherein the stator is provided at a periphery of the bearing retaining section; and
a frame formed either by a resin injection molding or by a die-cast molding such that the frame and the bearing retaining section are integrally formed.

12. The motor according to claim 11, wherein the rotor section has provided thereon an impeller having attached thereto a plurality of blades so as to generate an airflow when the rotor section rotates.

13. The motor according to claim 12, wherein on a periphery of the rotor section, provided is an impeller having attached thereto a plurality of blades for suctioning air inside the motor in an axial direction and for discharging in the axial direction when the rotor section rotates, wherein the impeller is surrounded by an air channel which is integrally formed with the frame.

14. The motor according to claim 12, wherein:
on an exterior of the rotor in a radial direction, provided is an impeller having arranged thereon in a circular manner a plurality of blades;
the impeller is inserted in an inner peripheral space of an outer shell housing formed outside of the frame, an exhaust outlet is provided at a section in the outer shell housing so as to allow the airflow is exhausted therefrom;
a top end of the outer shell housing is covered by a housing cover having therein at least one section for an air inlet; and
the motor is formed such that when the impeller rotates, air is suctioned through the air inlet and exhausted through the exhaust outlet, thereby forming an airflow.
